(19) United States
(12) Patent Application Publication
(10) Pub. No.: US 2026/0196421 A1
(43) Pub. Date: Jul. 9, 2026

(54) ROTARY MAGNETIC ANALOG SWITCH

(71) Applicant: Logitech Europe S.A., Lausanne (CH)

(72) Inventors: Lien Hsing Chen, Hsinchu City (CH); Feng-Hao Lin, Hsinchu City (TW)

(21) Appl. No.: 19/009,083

(22) Filed: Jan. 3, 2025

(51) Int. Cl. H01H 13/52; G01D 5/14; H01H 13/14; H01H 13/705; H01H 36/00

(52) U.S. Cl. CPC H01H 13/52; G01D 5/145; H01H 13/14; H01H 13/705; H01H 36/008

(57) ABSTRACT

In some embodiments, a key structure includes a housing; a plunger extending configured to be depressed and move along a linear range of motion; a mechanical transmission device including and input and an output; a rotating element, wherein the plunger is coupled to the input and the rotating element is coupled to the output of the mechanical transmission device, and wherein the mechanical transmission device converts a linear motion of the plunger at the input to a rotation motion of the rotating element at the output; a magnet coupled to the rotating element; a magnetic sensor configured adjacent to the magnet and operable to generate rotation sensor data corresponding to a rotation of the magnet; and one or more processors configured to control the magnetic sensor and detect the movement of the plunger along the linear range of motion based on the rotation sensor data.

### BACKGROUND

Computer peripheral devices are commonplace in modern society and are typically used to convert human-induced analog inputs (e.g., touches, clicks, motions, touch gestures, button presses, scroll wheel rotations, etc.) made in conjunction with computer peripheral devices into digital signals for computer processing. A computer peripheral device, or more broadly, an input device, can include any device that can provide data and control signals to a computing system. Some non-limiting examples of input devices include keyboards, computer mice, virtual reality and/or augmented reality controllers, touch pads, remote controls, gaming controllers, joysticks, trackballs, presenters, and the like.

Input devices have undergone many marked improvements over the last several decades. In some contemporary input devices, such as keyboards, analog keys have become popular for certain applications like competitive gaming. Analog keys can provide better resolution in key press detection that extends beyond a simple make or break connection, as found in conventional galvanic keyswitches, but are often susceptible to reduced performance characteristics such as poor linearity, dead zone(s), and sensitivities to key wobble, among other problems. As such, better solutions are needed.

Unless otherwise indicated herein, the materials described in this section are not prior art to the claims in this application and are not admitted as being prior art by inclusion in this section.

### SUMMARY

In certain embodiments, a key structure for a keyed input device comprises: a housing; a plunger (also referred to as a “stem”) extending from a top side of the housing and configured to be depressed and move along a linear range of motion; a mechanical transmission device (e.g., gear system) including and input and an output; a rotating element, wherein the plunger is coupled to the input of the mechanical transmission device, wherein the rotating element is coupled to the output of the mechanical transmission device, and wherein the mechanical transmission device converts linear motion of the plunger at the input to a rotation motion of the rotating element at the output; a magnet coupled to the rotating element; a magnetic sensor (e.g., Hall Effect sensor) configured adjacent to the magnet and operable to generate rotation sensor data corresponding to a rotation of the magnet; and one or more processors configured to control the magnetic sensor and detect the movement of the plunger along the linear range of motion based on the rotation sensor data. In some embodiments, the gear system can be a rack and pinion system, a miter gear system, a combination thereof, or other suitable gear or pulley system to convert linear motion to rotational motion. In some cases, the detected movement includes plunger position and speed of movement. The magnet sensor can be axially aligned with an axis of the rotating element, radially aligned with a side of the rotating element, or other suitable configuration. In some implementations, the plunger, mechanical transmission device, rotating element, magnet, and magnetic sensor are contained within the housing. The input device can be a keyboard or other keyed device.

In some embodiments, a method of operating a key structure comprises: receiving an input corresponding to a linear motion of a plunger; translating the linear motion of the plunger to a rotational motion of a rotating element, the rotating element including a magnet coupled thereto; controlling a magnetic sensor (e.g., Hall Effect sensor) configured adjacent to the magnet to generate rotation sensor data corresponding to a rotation of the magnet; and detecting the linear motion of the plunger based on the rotation sensor data. In some cases, translating the linear motion of the plunger to a rotational motion of a rotating element is performed by a mechanical transmission device (e.g., gear or pulley system, rack and pinion, miter gear, combinations thereof, etc.) with an input and output, wherein the plunger is coupled to the input of the mechanical transmission device, and wherein the rotating element is coupled to the output of the mechanical transmission device. In some cases, a housing contains the mechanical transmission device, rotating element, magnet, magnetic sensor, and at least a portion of the plunger. In some aspects, detecting the linear motion of the plunger includes detecting the plunger position and speed of plunger movement. The magnet sensor is axially aligned with an axis of the rotating element, radially aligned with a side of the rotating element, or other suitable configuration.

The terms and expressions that have been employed are used as terms of description and not of limitation, and there is no intention in the use of such terms and expressions of excluding any equivalents of the features shown and described or portions thereof. It is recognized, however, that various modifications are possible within the scope of the systems and methods claimed. Thus, it should be understood that, although the present system and methods have been specifically disclosed by examples and optional features, modification and variation of the concepts herein disclosed should be recognized by those skilled in the art, and that such modifications and variations are considered to be within the scope of the systems and methods as defined by the appended claims.

This summary is not intended to identify key or essential features of the claimed subject matter, nor is it intended to be used in isolation to determine the scope of the claimed subject matter. The subject matter should be understood by reference to appropriate portions of the entire specification of this disclosure, any or all drawings, and each claim.

The foregoing, together with other features and examples, will be described in more detail below in the following specification, claims, and accompanying drawings.

### BRIEF DESCRIPTION OF THE DRAWINGS

The features of the various embodiments described above, as well as other features and advantages of certain embodiments of the present invention, will be more apparent from the following detailed description taken in conjunction with the accompanying drawings, in which:

FIG. 1 shows a simplified example of a computer system that can include any of a variety of host computing devices and computer peripheral devices, including computer peripheral devices that can be configured to perform aspects of the various inventive concepts described herein;

FIG. 2 shows a simplified block diagram of a system for operating a computer peripheral device, according to certain embodiments;

FIG. 3 is a simplified block diagram of a host computing device, according to certain embodiments;

FIG. 4 shows a simplified representation of a conventional keyswitch with analog sensing;

FIG. 5 is a graph showing a characteristic curve of a conventional magnetic switch;

FIG. 6A shows a magnet and magnetic sensor configured in a coaxial alignment, according to certain embodiments;

FIG. 6B shows a magnet and magnetic sensor configured in a laterally oriented alignment, according to certain embodiments;

FIG. 6C shows a magnet and magnetic sensor configured in an orthogonal relationship relative to each other, according to certain embodiments;

FIG. 7A shows a mechanical transmission device configured to convert a linear motion of a plunger to a rotational motion of a rotating element, according to certain embodiments;

FIG. 7B shows another mechanical transmission device configured to convert a linear motion of a plunger to a rotational motion of a rotating element, according to certain embodiments;

FIG. 8 shows aspects of a key structure for a rotary magnetic switch, according to certain embodiments

FIGS. 9A-9C show different mounting configurations for a magnetic sensor in a rotary magnetic switch, according to certain embodiments;

FIG. 10A shows a table comparing performance characteristics of linear motion and rotational motion analog switches, according to certain embodiments;

FIG. 10B shows a graph plotting the linearity of a linear motion and a rotational motion analog switch, according to certain embodiments;

FIG. 10C shows a graph plotting noise characteristics of a linear motion and a rotational motion analog switch, according to certain embodiments; and

FIG. 11 shows a simplified flowchart of a method for operating a key structure with a rotary magnetic switch, according to certain embodiments.

Throughout the drawings, it should be noted that like reference numbers are typically used to depict the same or similar elements, features, and structures.

### DETAILED DESCRIPTION

Aspects of the present disclosure relate generally to computer peripheral devices, and more particularly to a rotary magnetic key structures, according to certain embodiments.

In the following description, various examples of rotary magnetic key structures are described. For purposes of explanation, specific configurations and details are set forth in order to provide a thorough understanding of the embodiments. However, it will be apparent to one skilled in the art that certain embodiments may be practiced or implemented without every detail disclosed. Furthermore, well-known features may be omitted or simplified to prevent any obfuscation of the novel features described herein.

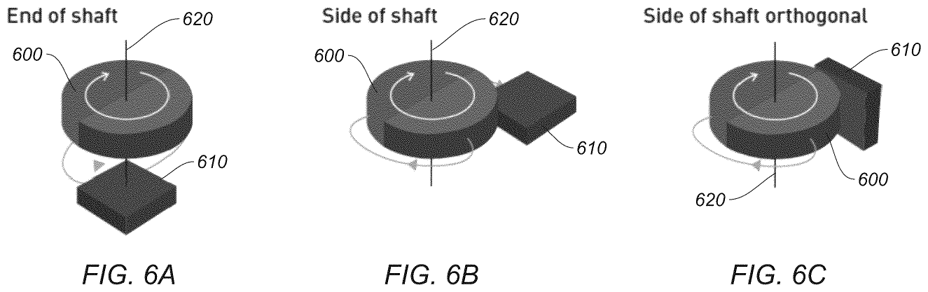

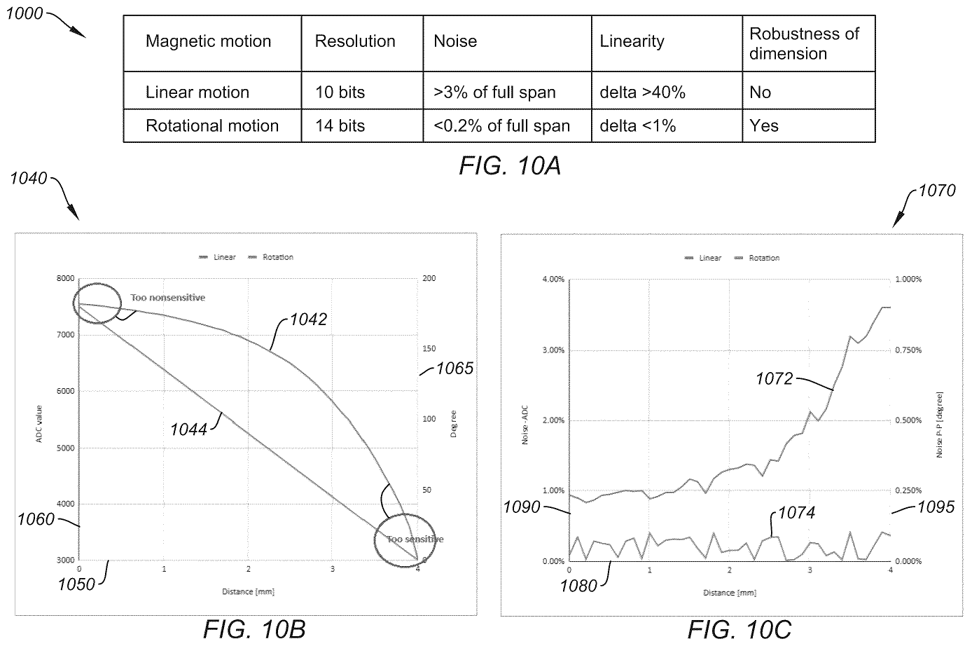

The following high-level summary is intended to provide a basic understanding of some of the novel innovations depicted in the figures and presented in the corresponding descriptions provided below. Aspects of the invention relate to rotary magnetic key structures for a keyed input device, such as a keyboard or the like. Conventional magnetic analog key structures detect linear (e.g., vertical) movement of a magnet coupled to a plunger by a magnetic sensor (e.g., Hall sensor). Some technical problems and deleterious conditions with these implementations include the presence of dead zones (e.g., areas at the beginning and end of the range of motion where sensing is too nonsensitive and sensitive, respectively, as shown at locations 1046 and 1048 of FIG. 10B), as well as inherently poor linearity and noise characteristics. Key wobble in a key structure can further exacerbate these problems as the key may have lateral movement during a key press, which can materially change between measurements. In such cases, more precise and costly methods may be used to control and mitigate these issues, like higher quality PCB layouts, more expensive sensors and corresponding infrastructure, mechanical structures (e.g., expensive materials for the plunger), advanced processing to mitigate said deleterious conditions, and the like. Alternatively, and preferably, the novel embodiments described herein (see, e.g., FIGS. 6A-11) can significantly mitigate these problems with superior performance, lower cost, and with consistent and robust performance.

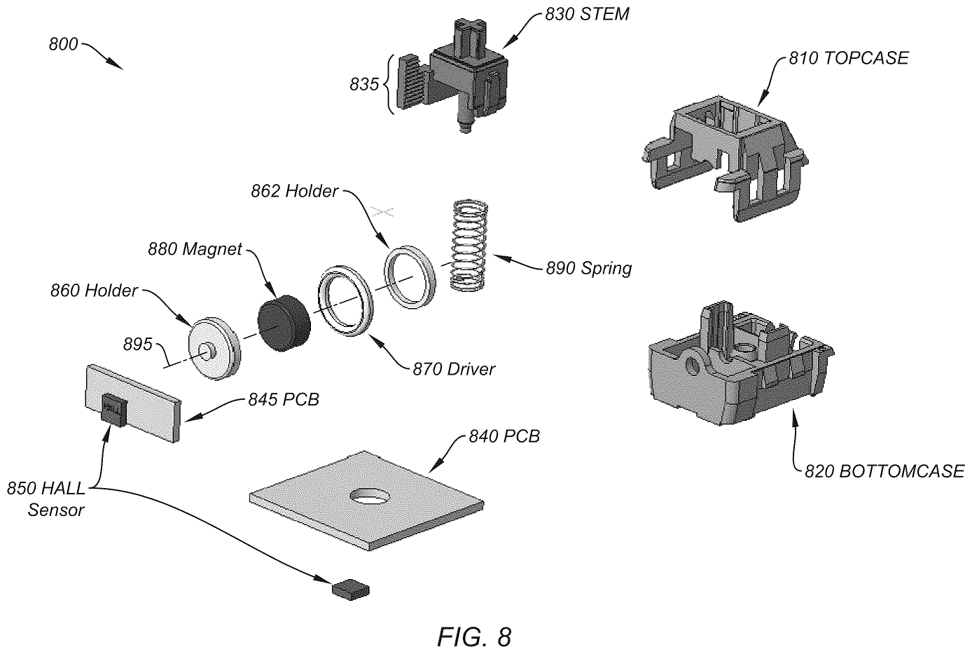

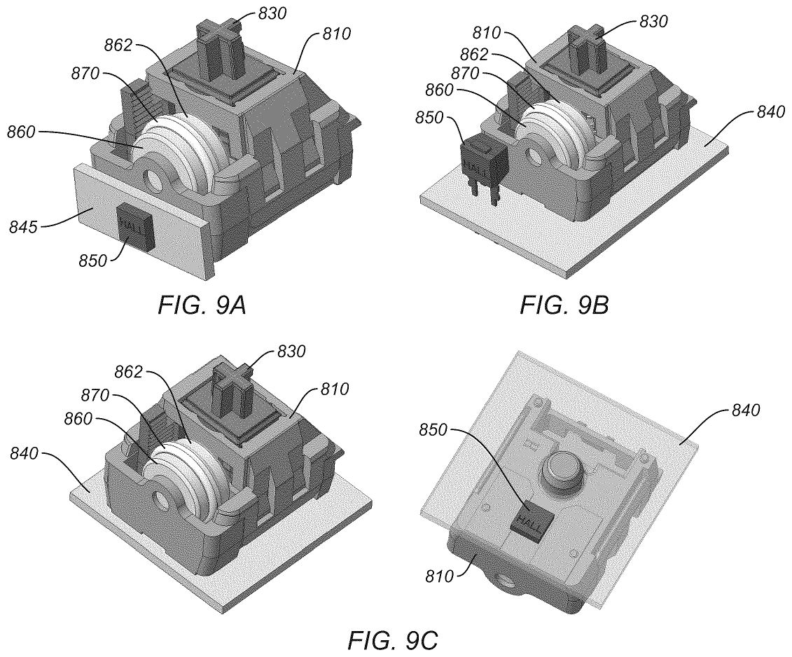

Aspects of the present disclosure provide technical solutions to the technical problems described above through the use of novel key switch architectures that incorporate rotary magnetic switches (e.g., analog switches), which take advantage of the low cost of Hall sensors by harnessing their excellent magnetic field detection properties while and avoiding their poor noise and linearity characteristics. More specifically, certain embodiments utilize a rotary magnetic analog switch implementation (see, e.g., FIGS. 8-9C) that converts a linear motion of a plunger (or “stem” typically coupled to a key cap) to a rotational motion of a rotation element (e.g., via a mechanical transmission device), where the stationary (e.g., no translational movement) rotation of the rotation element (e.g., with an embedded magnet) is detected by the magnetic sensor. Because the rotation element does not have translational movement, the positional relationship between the magnetic sensor and magnet of the rotation element stays substantially the same (e.g., relative movement can be less than 0.1 mm). Thus, the typical problems with poor magnetic sensor performance characteristics are avoided - problems like poor linearity of magnetic field detection over a range (no translation movement—only rotation), dead zones, and key wobble, and as a result higher precision and resolution are achieved, as compared to conventional implementations. Thus, a non-limiting, high level summary of the inventive concepts presented herein include a magnetic sensor configured close to a stationary (no lateral or translational movement) rotating element for a much more consistent, reliable, and accurate reading over a full range of motion because the distance of the magnetic sensor to the sensed element (e.g., magnet) will have negligible change, even with key wobble, resulting in highly improved performance characteristics (see, e.g., FIG. 10A-10C), as further described in detail throughout the present disclosure.

It is to be understood that this high-level summary is presented to provide the reader with a baseline understanding of some of the novel aspects of the present disclosure and a roadmap to the details that follow. This high-level summary in no way limits the scope of the various embodiments described throughout the detailed description and each of the figures referenced above are further described below in greater detail and in their proper scope.

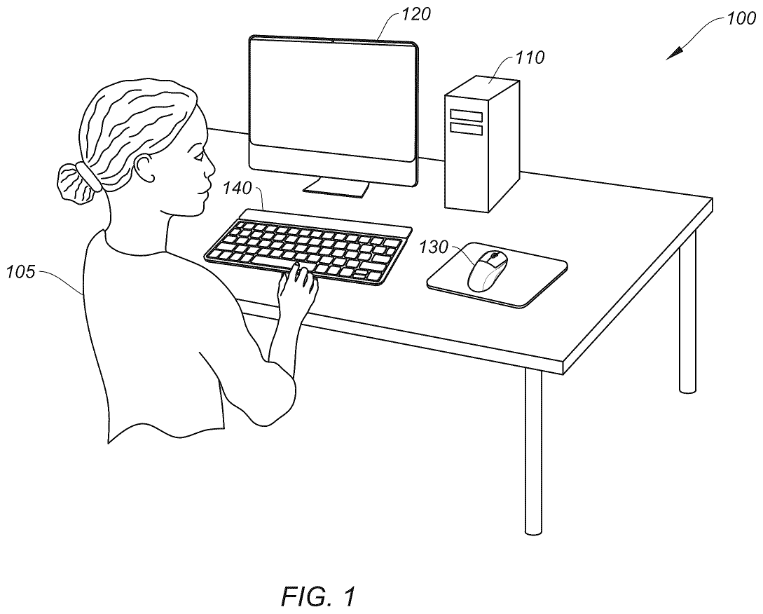

FIG. 1 shows a simplified example of a computer system 100 that can include any of a variety of host computing devices and computer peripheral devices, including computer peripheral devices (e.g., a computer mouse, keyboard, etc.) that can be configured to perform aspects of the various inventive concepts described herein. Computer system 100 can include computer 110, monitor 120, computer mouse 130, and keyboard 140. In some cases, keyboard 140 can be a “qwerty” style keyboard, or any suitable input device (e.g., internet-of-things device, AR/VR controller, remote controller, or the like) with one or more keys that can be configured as analog keys with travel and force detection, as further described throughout this disclosure. For computer system 100, keyboard 140 can be configured to control various aspects of computer 110 and monitor 120, as would be appreciated by one of ordinary skill in the art with the benefit of this disclosure. The monitor 120, computer mouse 130, and keyboard 140 may be referred to generally as “computer peripheral devices” or “input devices.” Computer peripheral devices 120-140 can be communicatively coupled to host computing device 110 and, in some cases, may be coupled to multiple host computing devices. Although many of the examples presented herein utilize analog keys in a keyboard-type computer peripheral device, it would be understood by those of ordinary skill in the art with the benefit of this disclosure that the usage of such structures can be applied to other types of input devices.

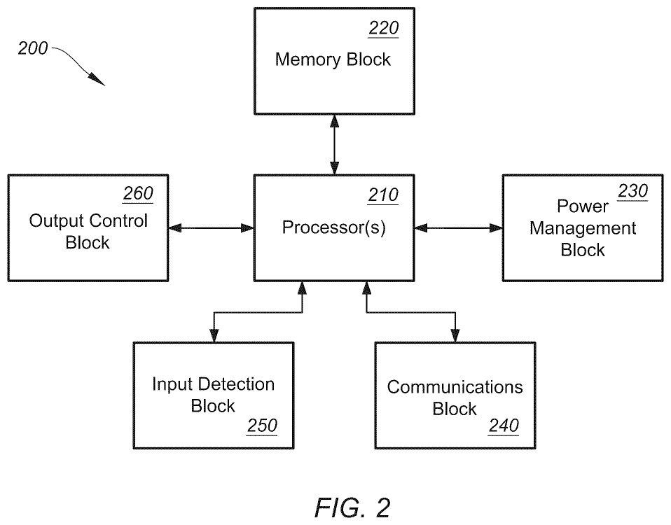

Computer 110 can be any suitable computing device including, but not limited to, a desktop computer, a laptop computer, a tablet or “phablet” computer, a smartphone, a PDA, a wearable device (e.g., smart watches, smart glasses), virtual reality/augmented reality (VR/AR) system, or the like. A host computing device may also be referred to herein as a “host computer,” “host device,” “computing device,” “computer,” or the like, and may include a machine-readable medium (not shown) configured to store computer code, such as driver software, firmware, and the like, where the computer code may be executable by one or more processors of the host computing device(s) (see, e.g., processor(s) 210 of FIG. 2) to control aspects of the host computing device, for instance, via the one or more computer peripheral devices.

FIG. 2 shows a system 200 for operating a computer peripheral device (e.g., computer mouse 130, keyboard 140, etc.), according to certain embodiments. Aspects of system 200 may be configured to operate any of the computer peripheral devices shown or not shown herein but within the wide purview of the present disclosure. System 200 may include processor(s) 210, a memory 220, a power management system 230, a communication module 240, an input detection module 250, and an output control module 260. Each of the system blocks 220-260 can be in electronic communication with processor(s) 210 (e.g., via a bus system). System 200 may include additional functional blocks that are not shown or discussed to prevent obfuscation of the novel features described herein. System blocks 220-260 (also referred to as “modules”) may be implemented as separate blocks, or alternatively, more than one system block may be implemented in a single block. In the context described herein, system 200 can be incorporated into any computer peripheral devices (e.g., input devices) described or mentioned herein and may be further configured with any of the analog key structures presented herein (see, e.g., FIGS. 8-9C), as would be appreciated by one of ordinary skill in the art with the benefit of this disclosure.

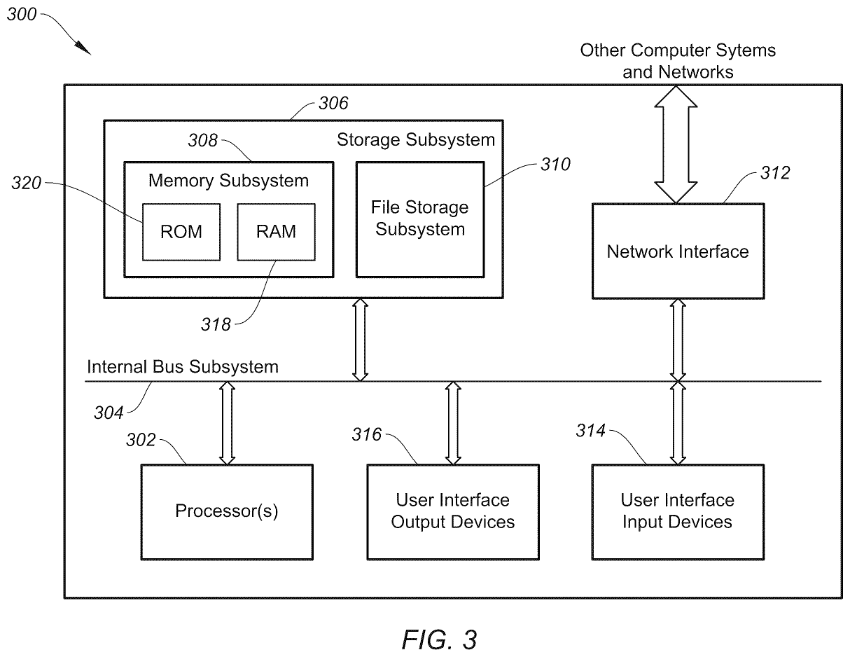

In certain embodiments, processor(s) 210 may include one or more microprocessors and can be configured to control the operation of system 200. Alternatively or additionally, processor(s) 210 may include one or more microcontrollers (MCUs), digital signal processors (DSPs), or the like, with supporting hardware and/or firmware (e.g., memory, programmable I/Os, etc.), and/or software, as would be appreciated by one of ordinary skill in the art. Processor(s) 210 can control some or all aspects of the operation of keyboard 140 (e.g., system blocks 220-260). Alternatively or additionally, some of system blocks 220-260 may include an additional dedicated processor, which may work in conjunction with processor(s) 210. For instance, MCUs, μCs, DSPs, and the like, may be configured in other system blocks of system 200. Communications block 240 may include a local processor, for instance, to control aspects of communication with host computer 110 (e.g., via Bluetooth, Bluetooth LE, RF, IR, hardwire, ZigBee, Z-Wave, Logitech Unifying, Lightspeed, or other communication protocol). Processor(s) 210 may be local to the computer peripheral device (e.g., contained therein), may be external to the computer peripheral device (e.g., off-board processing, such as by a corresponding host computing device), or a combination thereof. Processor(s) 210 may perform any of the various functions and methods described and/or covered by this disclosure in conjunction with any other system blocks in system 200. In some implementations, processor 302 of FIG. 3 may work in conjunction with processor(s) 210 to perform some or all of the various methods described throughout this disclosure. In some embodiments, multiple processors may enable increased performance characteristics in system 200 (e.g., speed and bandwidth), however, multiple processors are not required, nor necessarily germane to the novelty of the embodiments described herein. One of ordinary skill in the art would understand the many variations, modifications, and alternative embodiments that are possible.

Memory block (“memory”) 220 can store one or more software programs to be executed by one or more processors (e.g., processor(s) 210). It should be understood that “software” can refer to sequences of instructions that, when executed by processing unit(s) (e.g., processors, processing devices, etc.), cause system 200 to perform certain operations of software programs. The instructions can be stored as firmware residing in read-only memory (ROM), and/or applications stored in media storage that can be read into memory for execution by processing devices (e.g., processor(s) 210). Software can be implemented as a single program or a collection of separate programs and can be stored in non-volatile storage and copied in whole or in part to volatile working memory during program execution. In some embodiments, memory 220 may store data corresponding to inputs on the computer peripheral device, such as a detected movement of the computer peripheral device, a sensor (e.g., optical sensor, accelerometer, etc.), activation of one or more input elements (e.g., buttons, sliders, touch-sensitive regions, etc.), or the like. Stored data may be aggregated and sent via reports to a host computing device.

In certain embodiments, memory 220 can store the various data described throughout this disclosure. Memory 220 can be used to store any suitable data to perform any function described herein and as would be appreciated by one of ordinary skill in the art with the benefit of this disclosure. Memory 220 can be referred to as a storage system or storage subsystem and can store one or more software programs to be executed by processors (e.g., in processor(s) 210). It should be understood that “software” can refer to sequences of instructions that, when executed by processing unit(s) (e.g., processors, processing devices, etc.), cause system 200 to perform certain operations of software programs. The instructions can be stored as firmware residing in read-only memory (ROM) and/or applications stored in media storage that can be read into memory for processing by processing devices. Software can be implemented as a single program or a collection of separate programs and can be stored in non-volatile storage and copied in whole or in part to volatile working memory during program execution. From a storage subsystem, processing devices can retrieve program instructions to execute various operations (e.g., software-controlled switches, etc.) as described herein.

Power management system 230 can be configured to manage power distribution, recharging, power efficiency, and the like. In some embodiments, power management system 230 can include a battery (not shown), a Universal Serial Bus (USB)-based recharging system for the battery (not shown), and power management devices (e.g., voltage regulators—not shown), and a power grid within system 200 to provide power to each subsystem (e.g., communications block 240, etc.). In certain embodiments, the functions provided by power management system 230 may be incorporated into processor(s) 210. Alternatively, some embodiments may not include a dedicated power management block. For example, functional aspects of power management block 240 may be subsumed by another block (e.g., processor(s) 210) or in combination therewith. The power source can be a replaceable battery, a rechargeable energy storage device (e.g., super capacitor, Lithium Polymer Battery, NiMH, NiCd), or a corded power supply. The recharging system can be an additional cable (specific for the recharging purpose), or it can use a USB connection to recharge the battery.

Communication system 240 can be configured to enable wireless communication with a corresponding host computing device (e.g., 110), or other devices and/or computer peripherals, according to certain embodiments. Communication system 240 can be configured to provide radiofrequency (RF), Near-Field Communication (NFC), Bluetooth®, Logitech proprietary communication protocol (e.g., Unifying, Gaming Lightspeed, or others), infra-red (IR), ZigBee®, Z-Wave, or other suitable communication technology to communicate with other computing devices and/or peripheral devices. System 200 may optionally comprise a hardwired connection to the corresponding host computing device. For example, computer peripheral device 140 can be configured to receive a USB, FireWire®, Thunderbolt®, or other universal-type cables to enable bi-directional electronic communication with the corresponding host computing device or other external devices. Some embodiments may utilize different types of cables or connection protocol standards to establish hardwired communication with other entities. In some aspects, communication ports (e.g., USB), power ports, etc., may be considered as part of other blocks described herein (e.g., input detection module 250, output control module 260, etc.). In some aspects, communication system 240 can send reports generated by the processor(s) 210 (e.g., HID data, streaming or aggregated data, etc.) to a host computing device. In some cases, the reports can be generated by the processor(s) only, in conjunction with the processor(s), or other entity in system 200. Communication system 240 may incorporate one or more antennas, oscillators, etc., and may operate at any suitable frequency band (e.g., 2.4 GHz), etc. One of ordinary skill in the art with the benefit of this disclosure would appreciate the many modifications, variations, and alternative embodiments thereof.

Input detection module 250 can control the detection of a user-interaction with input elements on an input device. For instance, input detection module 250 can detect user inputs from motion sensors, keys, or buttons (e.g., depressible elements), roller wheels, scroll wheels, track balls, touch pads (e.g., one and/or two-dimensional touch sensitive touch pads), click wheels, dials, keypads, microphones, GUIs, touch-sensitive GUIs, proximity sensors (e.g., IR, thermal, Hall effect, inductive sensing, etc.), an image sensor based detection such as gesture detection (e.g., via webcam), audio based detection such as voice input (e.g., via microphone), or the like, as would be appreciated by one of ordinary skill in the art with the benefit of this disclosure. Alternatively, the functions of input detection module 250 or subset thereof can be subsumed by processor(s) 210, or in combination therewith.

In some embodiments, input detection module 250 can detect a touch or touch gesture on one or more touch sensitive surfaces on keyboard 140. Input detection block 250 can include one or more touch sensitive surfaces or touch sensors. Touch sensors generally comprise sensing elements suitable to detect a signal such as direct contact, electromagnetic or electrostatic fields, or a beam of electromagnetic radiation. Touch sensors can typically detect changes in a received signal, the presence of a signal, or the absence of a signal. A touch sensor may include a source for emitting the detected signal, or the signal may be generated by a secondary source. Touch sensors may be configured to detect the presence of an object at a distance from a reference zone or point (e.g., <5 mm), contact with a reference zone or point, or a combination thereof. Certain embodiments of computer peripheral device 140 may or may not utilize touch detection or touch sensing capabilities.

Input detection block 250 can include touch and/or proximity sensing capabilities. Some examples of the types of touch/proximity sensors may include, but are not limited to, resistive sensors (e.g., air-gap 4-wire based, based on carbon loaded plastics which have different electrical characteristics depending on the pressure (FSR), interpolated FSR, strain gages, etc.), capacitive sensors (e.g., surface capacitance, self-capacitance, mutual capacitance, etc.), optical sensors (e.g., light barrier type (default open or closed), infrared light barriers matrix, laser based diode coupled with photo-detectors that could measure the time of flight of the light path, etc.), acoustic sensors (e.g., piezo-buzzer coupled with microphones to detect the modification of a wave propagation pattern related to touch points, etc.), inductive sensors, magnetic sensors (e.g., Hall Effect, etc.), or the like.

Input detection module 250 may include a movement tracking sub-block that can be configured to detect a relative displacement (movement tracking) of a computer peripheral device. For example, input detection module 250 optical sensor(s) such as IR LEDs and an imaging array of photodiodes to detect the movement of a computer peripheral device relative to an underlying surface. A computer peripheral device may optionally include movement tracking hardware that utilizes coherent (laser) light. Movement tracking can provide positional data (e.g., delta X and delta Y data from the last sampling) or lift detection data. For example, an optical sensor can detect when a user lifts the computer peripheral device (e.g., computer mouse 130) off an underlying surface (also referred to as a “work surface”) and can send that data to processor(s) 210 for further processing. In some embodiments, processor(s) 210, the movement tracking block (which may include an additional dedicated processor), or a combination thereof, as would be appreciated by one of ordinary skill in the art with the benefit of this disclosure.

In certain embodiments, accelerometers can be used for movement detection. Accelerometers can be electromechanical devices (e.g., micro-electromechanical systems (MEMS) devices) configured to measure acceleration forces (e.g., static and dynamic forces). One or more accelerometers can be used to detect three-dimensional (3D) positioning. For example, 3D tracking can utilize a three-axis accelerometer or two two-axis accelerometers (e.g., in a “3D air mouse,” HMD, or another device). Accelerometers can further determine if the computer peripheral device has been lifted off an underlying surface and can provide movement data that may include the velocity, physical orientation, and acceleration of a computer peripheral device. In some embodiments, gyroscope(s) can be used in lieu of or in conjunction with accelerometer(s) to determine movement or input device orientation. In some embodiments, input detection block 250 can control aspects of one or more sensing elements, as described herein.

In some embodiments, output control module 260 can control various outputs for a corresponding computer peripheral device. For instance, output control module 260 may control a number of visual output elements (e.g., LEDs, LCD or LED screens/keys), displays, audio outputs (e.g., speakers), haptic output systems, or the like. One of ordinary skill in the art with the benefit of this disclosure would appreciate the many modifications, variations, and alternative embodiments thereof.

Although certain systems may not be expressly discussed, they should be considered as part of system 200, as would be understood by one of ordinary skill in the art. For example, system 200 may include a bus subsystem to transfer power and/or data to and from the different systems therein. It should be appreciated that system 200 is illustrative and that variations and modifications are possible. System 200 can have other capabilities not specifically described herein. Further, while system 200 is described with reference to particular blocks, it is to be understood that these blocks are defined for convenience of description and are not intended to imply a particular physical arrangement of component parts. Further, the blocks need not correspond to physically distinct components. Blocks can be configured to perform various operations (e.g., by programming a processor or providing appropriate control circuitry) and various blocks might or might not be reconfigurable depending on how the initial configuration is obtained.

System 200 can be applied in whole or in part (e.g., a subset of system blocks 210-260), or with additional blocks to realize the various inventive concepts described herein. In some cases, multiple systems 200 or portions thereof can be applied to a computer peripheral device. For example, some or all of the smart keyswitch embodiments described herein (see, e.g., FIGS. 6A-9) can incorporate aspects of system 200 to control sensing (e.g., optical, inductive, magnetic, mechanical), communication via I/O lines, wireless communications in some cases, output control (e.g., LEDs, haptics, etc.), or any other aspect via blocks 210-260, as would be appreciated by one of ordinary skill in the art with the benefit of this disclosure.

Embodiments of the present invention can be realized in a variety of apparatuses including electronic devices (e.g., computer peripheral devices) implemented using any combination of circuitry and software. Furthermore, aspects and/or portions of system 200 may be combined with or operated by other subsystems as required by design. For example, input detection module 250 and/or memory 220 may operate within processor(s) 210 instead of functioning as separate entities. In addition, the inventive concepts described herein can also be applied to any electronic device. Further, system 200 can be applied to any of the computer peripheral devices described in the embodiments herein, whether explicitly, referentially, or tacitly described (e.g., would have been known to apply to a particular computer peripheral device by one of ordinary skill in the art). The foregoing embodiments are not intended to be limiting and those of ordinary skill in the art with the benefit of this disclosure would appreciate the myriad applications and possibilities.

FIG. 3 is a simplified block diagram of a host computing device 300, according to certain embodiments. Host computing device 300 can implement some or all functions, behaviors, and/or capabilities described herein that would use electronic storage or processing, as well as other functions, behaviors, or capabilities not expressly described. Host computing device 300 can include a processing subsystem (processor(s)) 302, a storage subsystem 306, user interfaces 314, 316, and a communication interface 312. Computing device 300 can also include other components (not explicitly shown) such as a battery, power controllers, and other components operable to provide various enhanced capabilities. In various embodiments, host computing device 300 can be implemented in any suitable computing device, such as a desktop or laptop computer (e.g., desktop 110), mobile device (e.g., tablet computer, smart phone, mobile phone), wearable device, media device, or the like, or in peripheral devices (e.g., keyboards, etc.) in certain implementations.

Processor(s) 302 can include MCU(s), micro-processors, application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, or electronic units designed to perform a function, portions of functions, or a combination of methods, functions, etc., described throughout this disclosure.

Storage subsystem 306 can be implemented using a local storage and/or removable storage medium, e.g., using disk, flash memory (e.g., secure digital card, universal serial bus flash drive), or any other non-transitory storage medium, or a combination of media, and can include volatile and/or non-volatile storage media. Local storage can include a memory subsystem 308 including random access memory (RAM) 318 such as dynamic RAM (DRAM), static RAM (SRAM), synchronous dynamic RAM (e.g., DDR), or battery backed-up RAM or read-only memory (ROM) 320, or a file storage subsystem 310 that may include one or more code modules. In some embodiments, storage subsystem 306 can store one or more applications and/or operating system programs to be executed by processing subsystem 302, including programs to implement some or all operations described above that would be performed using a computer. For example, storage subsystem 306 can store one or more code modules for implementing one or more method steps described herein.

A firmware and/or software implementation may be implemented with modules (e.g., procedures, functions, and so on). A machine-readable medium tangibly embodying instructions may be used in implementing the methodologies described herein. Code modules (e.g., instructions stored in memory) may be implemented within a processor or external to the processor. As used herein, the term “memory” refers to a type of long term, short term, volatile, nonvolatile, or other storage medium, and is not to be limited to any particular type of memory or number of memories, or type of media upon which memory is stored.

Moreover, the term “storage medium” or “storage device” may represent one or more memories for storing data, including read only memory (ROM), RAM, magnetic RAM, core memory, magnetic disk storage mediums, optical storage mediums, flash memory devices and/or other machine-readable mediums for storing information. The term “machine-readable medium” includes, but is not limited to, portable or fixed storage devices, optical storage devices, wireless channels, and/or various other storage mediums capable of storing instruction(s) and/or data.

Furthermore, embodiments may be implemented by hardware, software, scripting languages, firmware, middleware, microcode, hardware description languages, and/or any combination thereof. When implemented in software, firmware, middleware, scripting language, and/or microcode, program code or code segments to perform tasks may be stored in a machine-readable medium such as a storage medium. A code segment (e.g., code module) or machine-executable instruction may represent a procedure, a function, a subprogram, a program, a routine, a subroutine, a module, a software package, a script, a class, or a combination of instructions, data structures, and/or program statements. A code segment may be coupled to another code segment or a hardware circuit by passing and/or receiving information, data, arguments, parameters, and/or memory contents. Information, arguments, parameters, data, etc. may be passed, forwarded, or transmitted by suitable means including memory sharing, message passing, token passing, network transmission, etc. These descriptions of software, firmware, storage mediums, etc., apply to systems 200 and 300, as well as any other implementations within the wide purview of the present disclosure. In some embodiments, aspects of the invention (e.g., surface classification) may be performed by software stored in storage subsystem 306, stored in memory 220 of a computer peripheral device, or both. One of ordinary skill in the art with the benefit of this disclosure would appreciate the many modifications, variations, and alternative embodiments thereof.

Implementation of the techniques, blocks, steps, and means described throughout the present disclosure may be done in various ways. For example, these techniques, blocks, steps, and means may be implemented in hardware, software, or a combination thereof. For a hardware implementation, the processing units may be implemented within one or more ASICs, DSPs, DSPDs, PLDs, FPGAs, processors, controllers, micro-controllers, microprocessors, other electronic units designed to perform the functions described above, and/or a combination thereof.

Each code module may comprise sets of instructions (codes) embodied on a computer-readable medium that directs a processor of a host computing device 110 to perform corresponding actions. The instructions may be configured to run in sequential order, in parallel (such as under different processing threads), or in a combination thereof. After loading a code module on a general-purpose computer system, the general-purpose computer is transformed into a special-purpose computer system.

Computer programs incorporating various features described herein (e.g., in one or more code modules) may be encoded and stored on various computer readable storage media. Computer readable media encoded with the program code may be packaged with a compatible electronic device, or the program code may be provided separately from electronic devices (e.g., via Internet download or as a separately packaged computer readable storage medium). Storage subsystem 306 can also store information useful for establishing network connections using the communication interface 312.

Computer system 300 may include user interface input devices 314 elements (e.g., touch pad, touch screen, scroll wheel, click wheel, dial, button, switch, keypad, microphone, etc.), as well as user interface output devices 316 (e.g., video screen, indicator lights, speakers, headphone jacks, virtual-or augmented-reality display, etc.), together with supporting electronics (e.g., digital to analog or analog to digital converters, signal processors, etc.). A user can operate input devices of user interface 314 to invoke the functionality of computing device 300 and can view and/or hear output from computing device 300 via output devices of user interface 316.

Processing subsystem 302 can be implemented as one or more processors (e.g., integrated circuits, one or more single core or multi core microprocessors, microcontrollers, central processing unit, graphics processing unit, etc.). In operation, processing subsystem 302 can control the operation of computing device 300. In some embodiments, processing subsystem 302 can execute a variety of programs in response to program code and can maintain multiple concurrently executing programs or processes. At a given time, some or all of a program code to be executed can reside in processing subsystem 302 and/or in storage media, such as storage subsystem 304. Through programming, processing subsystem 302 can provide various functionality for computing device 300. Processing subsystem 302 can also execute other programs to control other functions of computing device 300, including programs that may be stored in storage subsystem 304.

Communication interface (also referred to as network interface) 312 can provide voice and/or data communication capability for computing device 300. In some embodiments, communication interface 312 can include radio frequency (RF) transceiver components for accessing wireless data networks (e.g., Wi-Fi network; 3G, 4G/LTE, 5G; etc.), mobile communication technologies, components for short range wireless communication (e.g., using Bluetooth communication standards, NFC, etc.), other components, or combinations of technologies. In some embodiments, communication interface 312 can provide wired connectivity (e.g., universal serial bus (USB), Ethernet, universal asynchronous receiver/transmitter, etc.) in addition to, or in lieu of, a wireless interface. Communication interface 312 can be implemented using a combination of hardware (e.g., driver circuits, antennas, modulators/demodulators, encoders/decoders, and other analog and/or digital signal processing circuits) and software components. In some embodiments, communication interface 312 can support multiple communication channels concurrently.

User interface input devices 314 may include any suitable computer peripheral device (e.g., computer mouse, keyboard, gaming controller, remote control, stylus device, etc.), as would be appreciated by one of ordinary skill in the art with the benefit of this disclosure. User interface output devices 316 can include display devices (e.g., a monitor, television, projection device, etc.), audio devices (e.g., speakers, microphones), haptic devices, etc. Note that user interface input and output devices are shown to be a part of system 300 as an integrated system. In some cases, such as in laptop computers, this may be the case as keyboards and input elements as well as display and output elements are integrated on the same host computing device. In some cases, the input and output devices may be separate from system 300, as shown in FIG. 1. One of ordinary skill in the art with the benefit of this disclosure would appreciate the many modifications, variations, and alternative embodiments thereof.

It will be appreciated that computing device 300 is illustrative and that variations and modifications are possible. A host computing device can have various functionality not specifically described (e.g., voice communication via cellular telephone networks) and can include components appropriate to such functionality. While the computing device 300 is described with reference to particular blocks, it is to be understood that these blocks are defined for convenience of description and are not intended to imply a particular physical arrangement of component parts. For example, processing subsystem 302, storage subsystem 306, user interfaces 314, 316, and communications interface 312 can be in one device or distributed among multiple devices. Further, the blocks need not correspond to physically distinct components. Blocks can be configured to perform various operations (e.g., by programming a processor or providing appropriate control circuitry) and various blocks might or might not be reconfigurable depending on how an initial configuration is obtained. Embodiments of the present invention can be realized in a variety of apparatus including electronic devices implemented using a combination of circuitry and software. Host computing devices or even peripheral devices described herein can be implemented using system 300.

### Rotary Magnetic Analog Switch

Aspects of the present disclosure include the use of novel key switch architectures that incorporate rotary magnetic switches (e.g., analog switches) that convert a linear motion of a plunger (e.g., up and down movement) to a rotational motion of a rotation element (e.g., rotating on an axis perpendicular to the axis defined by the movement of the plunger) via a mechanical transmission device (e.g., gear system), where the stationary (e.g., no translational movement) rotation of a magnet embedded in the rotation element is detected by the magnetic sensor. Because the rotation element does not have translational movement, the positional relationship between the magnetic sensor and magnet of the rotation element stays substantially the same (e.g., less than 0.1 mm translational movement) and the typical problems with poor magnetic sensor performance characteristics (e.g., linearity, dead zones, key wobble) are avoided and higher precision and resolution can be achieved because the magnetic sensor is measuring rotation of the rotation element at a fixed, close distance. Thus, a non-limiting, high level summary of the inventive concepts presented herein include a magnetic sensor configured close to a stationary (no lateral or translational movement) rotating element for a much more consistent, reliable, and accurate reading over a full range of motion of a key plunger because the distance of the magnetic sensor to the sensed element (e.g., magnet) will have negligible change as the rotation element rotates, even with key wobble, that results in highly improved performance characteristics.

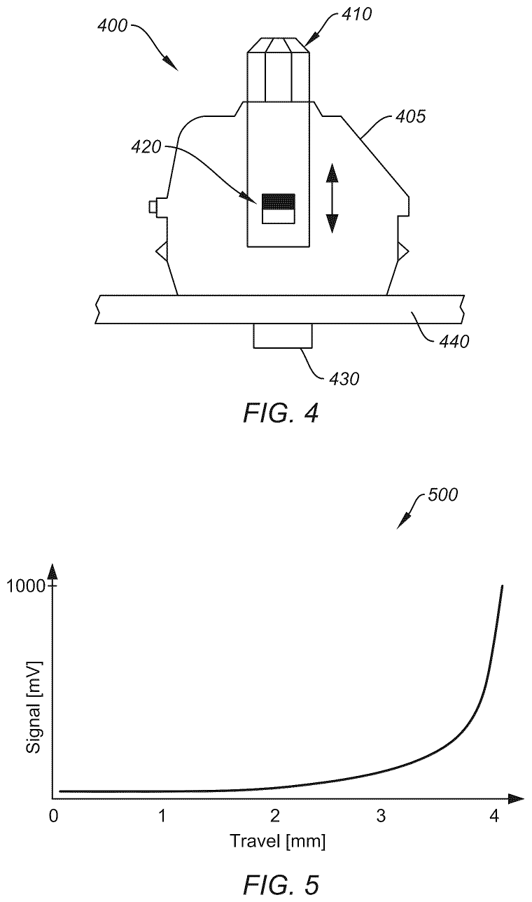

FIG. 4 shows a simplified representation of a conventional keyswitch with analog sensing. Keyswitch 400 is seated on a printed circuit board (PCB) 440 or other substrate. Keyswitch 400 includes a plunger 410 configured to move linearly along a range of motion within key body 405. A magnet 420 or other ferromagnetic material is coupled to plunger 410. A magnetic sensor, such as a Hall Sensor 430, is coupled to PCB 440 and is operable to detect aspects of the magnetic field generated by magnet 420, which can be used to detect the movement of plunger 410 for analog detection. Despite the advantages presented by analog sensing over standard mechanical key switch technology (e.g., greater key press detection resolution), they are subject to the poor magnetic sensor performance characteristics (e.g., linearity, dead zones, key wobble) described above.

FIG. 5 is a graph 500 that shows diverging sensitivity characteristics for a key structure with a conventional analog sensor architecture, such as shown with keyswitch 400. Graph 500 plots a detection sensitivity over a range of motion for a keyswitch (e.g., 4 mm travel). Conventional analog sensing architectures can be highly nonlinear and can have poor sensing performance as the target (e.g., magnet 420) moves further away (e.g., when the plunger is released) from the sensing device (e.g., Hall sensor). For example, FIG. 5 shows that there is key travel over at least half of the travel range (e.g., 2 mm) before there is any substantial divergence in sensitivity with no discernable change in sensitivity in response to movement of the plunger, which makes it difficult for a user to intuitively depress the key plunger to achieve a particular analog output based on displacement because of the non-linearity of the signal over the travel range. It is only when the plunger is pressed between about 3 to 4 mm that the signal substantially increases in sensitivity, which can mis-activate the key stroke in this region. Relative linearity occurs around 2.5-3.5 mm and remains nonlinear outside of that range, which can make using the analog signal over the full range of motion challenging to process without significant computational resources to compensate for the nonlinear performance. Additionally, the ends of the travel range (e.g., near 0 mm and 4 mm) either lack sufficient sensitivity (former) or are too sensitive (latter), thereby creating dead zones, as described above and shown in FIG. 10B, further described below.

FIGS. 6A-6C show aspects of how a sensor and translationally stationary magnetic element can be configured relative to each other, according to certain embodiments. As noted above, because the rotation element does not have translational movement, the positional relationship between the magnetic sensor and magnet of the rotation element stays substantially the same (e.g., less than 0.1 mm translational movement) and the typical problems with poor magnetic sensor performance characteristics (e.g., linearity, dead zones, key wobble) are avoided and higher precision and resolution can be achieved because the magnetic sensor is measuring rotation of the rotation element at a fixed, close distance.

FIG. 6A shows an arrangement of a magnet and sensor in a rotary magnetic switch application, according to certain embodiments. The magnet 600 and magnet sensor (e.g., Hall sensor) 610 are configured in coaxial alignment and at a fixed distance. As magnet 600 rotates, there is no linear translation between magnet 600 and sensor 610, they remain at an optimal distance (e.g., based on sensor location, magnetic dimensions, etc., as would be appreciated by one of ordinary skill in the art with the benefit of this disclosure), thus there are no dead zones and good linearity.

FIG. 6B shows another arrangement of a magnet and sensor in a rotary magnetic switch application, according to certain embodiments. The magnet 600 and magnet sensor 610 are configured in a laterally oriented alignment, according to certain embodiments. As magnet 600 rotates, there is also no translational movement between magnet 600 and sensor 610. Sensor 610 is laterally configured, but off center. In some embodiments, sensor 610 can be on or off axis, closer, farther, above, below, etc., which may be needed not only for good detection characteristics, but to accommodate the available space inside of the computer peripheral device. Typically, exemplary embodiments would have little to no offset or tilt between magnet 600 and sensor 610. In another embodiment, FIG. 6C shows an arrangement of a magnet and sensor in a rotary magnetic switch application configured in a laterally oriented alignment and orthogonal to the axis of rotation for magnet 600, according to certain embodiments.

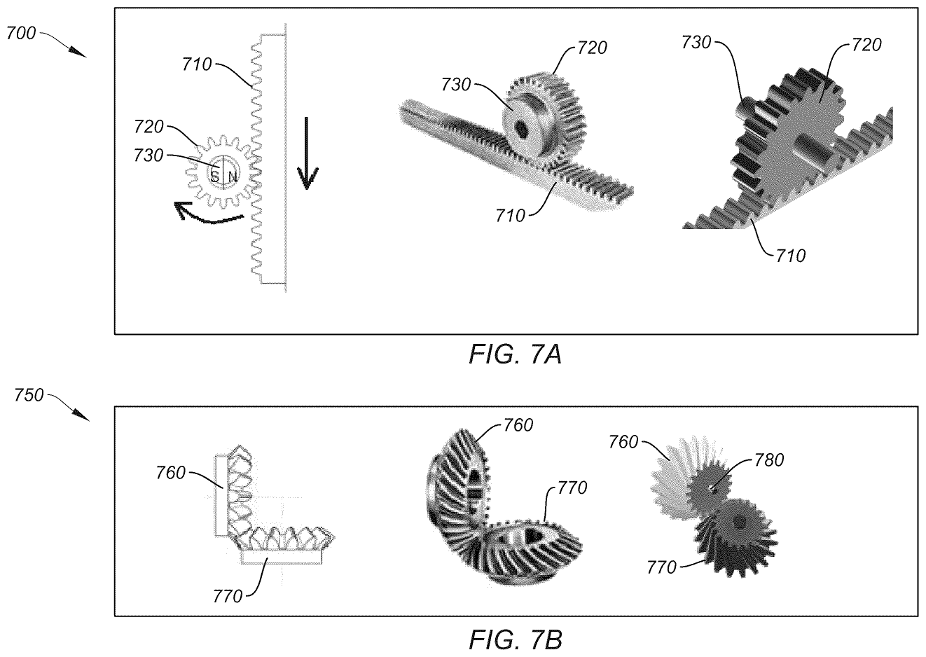

FIG. 7A shows a mechanical transmission device 700 configured to convert a linear motion of a plunger to a rotational motion of a rotating element, according to certain embodiments. Mechanical transmission device 700 can use gears, belts, or other suitable implementation of transmission, as would be appreciated by one of ordinary skill in the art with the benefit of this disclosure. Mechanical transmission device 700, as shown, includes a rack 710 and pinion 720 system with a magnet 730 configured within pinion 720. Rack 710 can be directly or indirectly coupled to the plunger (not shown), such that rack 710 moves (e.g., up and down) linearly and commensurate with the movement of the plunger. As rack 710 moves linearly as the plunger is pressed and released, pinion 720 rotates in a fixed position, and the linear translation of the rack is converted to rotational movement of pinion 720 and magnet 730.

FIG. 7B shows another mechanical transmission device 750 configured to convert a linear motion of a plunger to a rotational motion of a rotating element, according to certain embodiments. Mechanical transmission device 750, as shown, includes miter gears 760 and 770, arranged in an orthogonal relationship and coupled together via complementary interleaving teeth configured thereon, as would be appreciated by one of ordinary skill in the art with the benefit of this disclosure. Miter gears 760, 770 can be used to convert a rotation direction for certain sensor requirements, and may be paired with the embodiment of FIG. 7A to convert linear motion of the plunger to rotational motion of a rotating element, as would be appreciated by one of ordinary skill in the art with the benefit of this disclosure.

FIG. 8 shows aspects of a key structure 800 for a rotary magnetic switch, according to certain embodiments. Key structure 800 includes a top case 810 and bottom case 820, which may couple together in a complimentary fit arrangement. Plunger 830 (also referred to as a “stem”) can be configured within the top case 810 and bottom case 820 enclosure. As shown in FIG. 8, plunger 830 can include a linear, geared portion 835. Bottom case 820 can be coupled to printed circuit board (PCB) 840 or other suitable substrate.

In some embodiments, plunger 830 may be coupled to a biasing mechanism 890 (e.g., spring), which can be used to provide a return force to return a pressed plunger back to a neutral, unpressed position. In some implementations, a mechanical transmission system can be coupled to or part of plunger 830 (rack 835) to convert a linear motion of the plunger 830 to a rotational motion of a rotating element that includes a magnetic or ferromagnetic material. Referring to FIG. 8, the mechanical translation system can include any suitable rotating element with a magnetic material configured therein. For instance, such systems can include a magnet 880 with driver 870 enclosed and arranged longitudinally on an axis 895 via holders 860 and 862. Magnet 880 can be secured via compression fit, hardware (e.g., screws, tabs, pins, etc.), or other suitable method of securing magnet 880 to operate in the manner described herein. Rotating element (“driver”) 870 can be configured to interface with rack 435 such that as the plunger is depressed linearly (e.g., in an up and down motion), rotating element 870 rotates, and thereby rotates the magnet 880 (e.g., on an axis normal to the range of motion of plunger 830) in a manner similar to the rack and pinion example in FIG. 7A. In some cases, rotating element 870 may housing magnet 880, or be coupled to magnet 880 directly or indirectly. Any suitable driving mechanism, as shown in FIGS. 7A and 7B, or other mechanical transmission system can be used, as would be appreciated by one of ordinary skill in the art with the benefit of this disclosure. Top case and bottom case 820 may enclose biasing mechanism 890 and all of the mechanical transmission system, or a subset thereof (e.g., in cases where certain features are configured outside of the top and bottom cases).

A magnetic sensor 850 (e.g., Hall sensor) can be configured adjacent to magnet 880 and detect its rotation. In some embodiments, sensor 850 can be coupled to PCB 840 in a location lateral to magnet 880, as shown. Preferably, sensor 850 is configured sufficiently close to magnet 880 (e.g., 1 mm), with minimal offset and tilt relative to each other, along with no lateral translation between sensor 850 and magnet 880 as it rotates as the plunger is depressed) to ensure good resolution, linearity, and to eliminate or substantially reduce dead zones. Thus, rather than magnitude detection (e.g., measuring linear motion and position of a magnet and corresponding plunger), circular motion is detected (e.g., angle deflection), which can be significantly more precise, as further described below.

In some implementations, sensor 850 is configured longitudinally and axially (e.g., relative to axis 895) relative to magnet 880, and may be directly on axis or off axis. In some cases, sensor 850 can be configured perpendicular and radial to magnet 880. Sensor 850 can be mounted on any suitable substrate, such as PCB 840 or PCB 845, in any suitable manner (e.g., through hole, surface mount, top mount, bottom mount, etc., within the enclosure defined by coupled top case 810 and bottom case 820, outside of the top/bottom case enclosure, etc.), as would be appreciated by one of ordinary skill in the art with the benefit of this disclosure. In some aspects, sensor 850 may be controlled by one or more processors 210, 302, or a combination thereof. Typically, sensor 850 is operable to detect the pole boundary transition of magnet 850 (e.g., ring magnet) attached to the rotating element. This information can be provided to a processor 210, and by counting the pulses, a speed, acceleration, and amount of rotation can be determined.

In some exemplary embodiments, a key structure for a keyed input device, (e.g., keyboard 140) includes: a housing (e.g., top case coupled to a bottom case); a plunger extending from a top side of the housing and configured to be depressed and move along a linear range of motion; a mechanical transmission device including and input and an output; a rotating element, wherein the plunger is coupled to the input of the mechanical transmission device (e.g., gear system), wherein the rotating element is coupled to the output of the mechanical transmission device, and wherein the mechanical transmission device converts linear motion of the plunger at the input to a rotation motion of the rotating element at the output; a magnet coupled to the rotating element; a magnetic sensor (e.g., Hall effect sensor) configured adjacent to the magnet (e.g., axially aligned with an axis of the rotating element, radially aligned with a side of the rotating element, etc.) and operable to generate rotation sensor data corresponding to a rotation of the magnet; and one or more processors configured to control the magnetic sensor and detect the movement of the plunger (e.g., speed, position, acceleration, etc.) along the linear range of motion based on the rotation sensor data. In some cases, the plunger, mechanical transmission device, rotating element, magnet, and magnetic sensor are contained within the housing.

FIGS. 9A-9C show different mounting configurations for a magnetic sensor in a rotary magnetic switch, according to certain embodiments. FIG. 9A shows key structure 800 with a rotary magnetic switch, and a magnetic sensor 850 mounted on external PCB 845 (e.g., via surface mount) and oriented along axis 895 and offset. FIG. 9B shows key structure 800 with a rotary magnetic switch, and a magnetic sensor 850 mounted on a top side of external PCB 840 (e.g., via through hole mount) and oriented along axis 895 and offset. FIG. 9C shows key structure 800 with a rotary magnetic switch, and a magnetic sensor 850 surface mounted on a bottom side of external PCB 840 (e.g., via through hole mount) and oriented radially from magnet 880 and normal to axis 895.

FIG. 10A shows a table 1000 comparing performance characteristics of linear motion and rotational motion for analog switches, according to certain embodiments. Table 1000 compares resolution, noise, linearity, and robustness of dimension. For analog keyswitches with conventional linear motion detection (see, e.g., FIG. 4), resolution is 10 bits, noise is >3% of full span, linearity has a delta of >40%, and has little robustness of dimension, which may correspond to component dimension and configuration tolerances and environmental disturbance (e.g., impacts). For analog keyswitches with rotational linear motion detection (see, e.g., FIGS. 8-9C), resolution is 14 bits, noise is <0.2%% of full span, linearity has a delta of <1%, and has robustness of dimension. Resolution relates to the sensor specification (ADC resolution) and units is typically in bits. Higher bits corresponds to higher precision. In some cases, signal noise causes the measured ADC value to fluctuate even when the plunger is stationary. Span may relate to the total ADC range over the total travel distance. Linearity error can estimate system performance, and can relate to a maximum deviation from a linear curve over the output range. Robustness of dimension can relate how much the system allows for loose dimension requirements, such as magnet dimensions, distance between sensor and magnet, total travel variation, etc. The linearity may affect the user experience as with systems with poor linearity, the user may detect that the activation does not closely and consistently follow the key press force.

FIG. 10B shows a graph 1040 plotting the linearity of a linear motion and a rotational motion analog switch, according to certain embodiments. Graph 1040 presents linearity by plotting an analog digital converter (ADC) measurement 1060 vs. a distance of key plunger movement (mm) 1050 for both a linear motion analog switch (plot 1044), like that shown in FIG. 4, and a rotational motion analog switch (plot 1042), for instance as shown in FIGS. 8-9C.

In the conventional analog keyswitch of plot 1042, as the key plunger is pressed and moves along its linear range of motion from an at rest position (e.g., 0 mm) to full deflection (e.g., 4 mm), the sensitivity of measurement changes significantly, with areas (e.g., dead zones) where sensitivity is poor near the ends of the linear range of motion. This is because the distance between the sensor and the magnet changes (e.g., up to 4 mm) as the plunger is depressed. Linearity can also be negatively affected by wobble or tilt of the magnet relative to the sensor as the plunger is moved along its range of motion. Poor linearity makes accurate position and movement detection for the plunger difficult to achieve, which can require significant computational resources to mitigate the inaccuracy, and in some cases the combination of dead zones, wobble, tilt, and poor linearity cannot be completely mitigated.

In the rotational motion analog keyswitch of plot 1044, as the key plunger is pressed and moves along its linear range of motion from an at rest position (e.g., 0 mm) to full deflection (e.g., 4 mm), the sensitivity of measurement remains linear and with no dead zones at the ends of the linear range of motion. This is due, in part, to the fixed position of the rotating magnet relative to the sensor. Instead of detecting a moving magnetic field over a 4 mm range of motion, the magnetic field is detected as the magnet rotates (e.g., 180 degrees) a fixed distance (e.g., 2 mm) over the entire range of motion of the plunger and over the rotation of the magnet (axis 1065). Further, because the magnet has no translational movement, wobble and tilt can be significantly reduce or practically eliminated, further improving the linearity of readings. In some cases, the magnet may rotate at, above, or below 180 degrees, as would be appreciated by one of ordinary skill in the art with the benefit of this disclosure.

FIG. 10C shows a graph 1070 plotting noise characteristics (e.g., maximum deviation of the ADC value during measurement) of a linear motion and a rotational motion analog switch, according to certain embodiments. Graph 1070 presents noise characteristics by plotting an ADC measurement 1090 vs. a distance of key plunger movement (mm) 1080 for both a linear motion analog switch (plot 1072), like that shown in FIG. 4, and a rotational motion analog switch (plot 1074), as shown in FIGS. 8-9C.

In the conventional analog keyswitch of plot 1072, as the key plunger is pressed and moves along its linear range of motion from an at rest position (e.g., 0 mm) to full deflection (e.g., 4 mm), the noise measurement increases significantly and nonlinearly, changing from about a 1% noise measurement to about 3.5%. The high noise value at the end of the range of motion is very high and unstable, which significantly and negatively impacts accuracy.

In the rotational motion analog keyswitch of plot 1074, as the key plunger is pressed and moves along its linear range of motion from an at rest position (e.g., 0 mm) to full deflection (e.g., 4 mm), the noise measurement remains relatively consistent with some variation that stays below about 0.3%. Because the noise level of the rotational motion analog key switch (plot 1074) is significantly lower and relatively consistent throughout the range of motion, as compared to plot 1072, the rotational motion analog keyswitch is more stable with less likely of any chance of mis-triggering (also referred to as mis-activation).

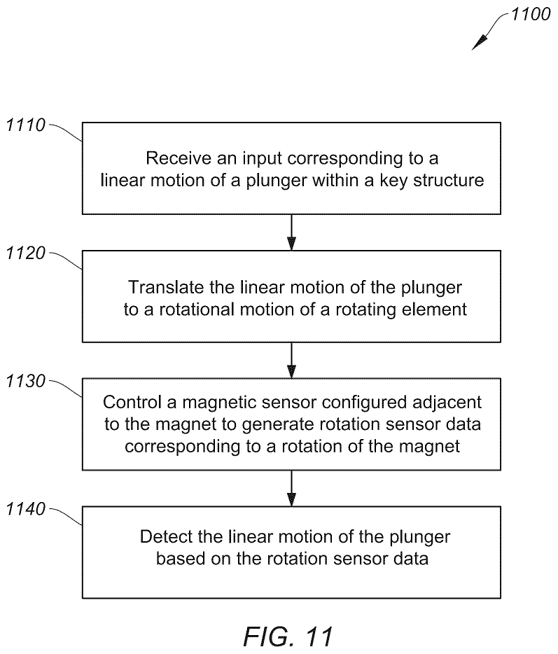

FIG. 11 is a simplified flow chart showing aspects of a method 1100 for operating a key structure with a rotary magnetic switch, according to certain embodiments. Method 1100 can be performed by processing logic that may comprise hardware (circuitry, dedicated logic, etc.), software operating on appropriate hardware (such as a general purpose computing system or a dedicated machine), firmware (embedded software), or any combination thereof. In certain embodiments, method 1100 can be performed by aspects of system 200, system 300, or a combination thereof.

At operation 1110, method 1100 can include receiving an input corresponding to a linear motion of a plunger, according to certain embodiments.

At operation 1120, method 1100 can include translating the linear motion of the plunger to a rotational motion of a rotating element, the rotating element including a magnet coupled thereto, according to certain embodiments. Translating the linear motion of the plunger to a rotational motion of a rotating element can be performed by a mechanical transmission device with an input and output, wherein the plunger is coupled to the input of the mechanical transmission device, and wherein the rotating element is coupled to the output of the mechanical transmission device. In some aspects, the mechanical transmission device can be a gear system, such as a rack and pinion system, miter gear system, or the like, as shown in FIGS. 7A-7B, 8, and 9A-9C, or other suitable mechanical transmission system, such as belt drives, pulley systems, or the like.

At operation 1130, method 1100 can include controlling a magnetic sensor configured adjacent to the magnet to generate rotation sensor data corresponding to a rotation of the magnet, according to certain embodiments. In some cases, the magnetic sensor can be a Hall Effect sensor. The magnetic sensor can be axially aligned or radially aligned (among other types of alignment schemas) with the rotating element.

At operation 1140, method 1100 can include detecting the linear motion of the plunger based on the rotation sensor data, according to certain embodiments. In some cases, detecting the linear motion of the plunger includes plunger position and speed of movement. A housing of the key structure can include a housing that contains the mechanical transmission device, rotating element, magnet, magnetic sensor, and at least a portion of the plunger (a portion may protrude from an end of the key structure and interface with a key cap, for example).

It should be appreciated that the specific steps illustrated in FIG. 11 provide a particular method 1100 for operating a key structure with a rotary magnetic switch, according to certain embodiments. Other sequences of steps may also be performed according to alternative embodiments. Furthermore, additional steps may be added or removed depending on the particular application. For instance, in some embodiments, a method may include steps 1130-1140, or just 1140, such that portions of method 1100 are performed by a single entity (e.g., processor 210) or multiple entities (e.g., processor 210, input detection block 250). Any combination of steps can be used and one of ordinary skill in the art with the benefit of this disclosure would understand the many variations, modifications, and alternative embodiments thereof.

Most embodiments utilize at least one network that would be familiar to those skilled in the art for supporting communications using any of a variety of commercially available protocols, such as TCP/IP, UDP, OSI, FTP, UPnP, NFS, CIFS, and the like. The network can be, for example, a local area network, a wide-area network, a virtual private network, the Internet, an intranet, an extranet, a public switched telephone network, an infrared network, a wireless network, and any combination thereof.

In embodiments utilizing a network server as the operation server or the security server, the network server can run any of a variety of server or mid-tier applications, including HTTP servers, FTP servers, CGI servers, data servers, Java servers, and business application servers. The server(s) also may be capable of executing programs or scripts in response to requests from user devices, such as by executing one or more applications that may be implemented as one or more scripts or programs written in any programming language, including but not limited to Java®, C, C # or C++, or any scripting language, such as Perl, Python or TCL, as well as combinations thereof. The server(s) may also include database servers, including without limitation those commercially available from Oracle®, Microsoft®, Sybase®, and IBM®.

Such devices also can include a computer-readable storage media reader, a communications device (e.g., a modem, a network card (wireless or wired), an infrared communication device, etc.), and working memory as described above. The computer-readable storage media reader can be connected with, or configured to receive, a non-transitory computer-readable storage medium, representing remote, local, fixed, and/or removable storage devices as well as storage media for temporarily and/or more permanently containing, storing, transmitting, and retrieving computer-readable information. The system and various devices also typically will include a number of software applications, modules, services or other elements located within at least one working memory device, including an operating system and application programs, such as a client application or browser. It should be appreciated that alternate embodiments may have numerous variations from that described above. For example, customized hardware might also be used and/or particular elements might be implemented in hardware, software (including portable software, such as applets) or both. Further, connections to other computing devices such as network input/output devices may be employed.

Numerous specific details are set forth herein to provide a thorough understanding of the claimed subject matter. However, those skilled in the art will understand that the claimed subject matter may be practiced without these specific details. In other instances, methods, apparatuses, or systems that would be known by one of ordinary skill have not been described in detail so as not to obscure claimed subject matter. The various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment.

While the present subject matter has been described in detail with respect to specific embodiments thereof, it will be appreciated that those skilled in the art, upon attaining an understanding of the foregoing may readily produce alterations to, variations of, and equivalents to such embodiments. Accordingly, it should be understood that the present disclosure has been presented for purposes of example rather than limitation, and does not preclude inclusion of such modifications, variations, and/or additions to the present subject matter as would be readily apparent to one of ordinary skill in the art. Indeed, the methods and systems described herein may be embodied in a variety of other forms; furthermore, various omissions, substitutions and changes in the form of the methods and systems described herein may be made without departing from the spirit of the present disclosure. The accompanying claims and their equivalents are intended to cover such forms or modifications as would fall within the scope and spirit of the present disclosure.

Although the present disclosure provides certain example embodiments and applications, other embodiments that are apparent to those of ordinary skill in the art, including embodiments which do not provide all of the features and advantages set forth herein, are also within the scope of this disclosure. Accordingly, the scope of the present disclosure is intended to be defined only by reference to the appended claims.

Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provide a result conditioned on one or more inputs. Suitable computing devices include multi-purpose microprocessor-based computer systems accessing stored software that programs or configures the computing system from a general-purpose computing apparatus to a specialized computing apparatus implementing one or more embodiments of the present subject matter. Any suitable programming, scripting, or other type of language or combinations of languages may be used to implement the teachings contained herein in software to be used in programming or configuring a computing device.

Embodiments of the methods disclosed herein may be performed in the operation of such computing devices. The order of the blocks presented in the examples above can be varied —for example, blocks can be re-ordered, combined, and/or broken into sub-blocks. Certain blocks or processes can be performed in parallel.

Conditional language used herein, such as, among others, “can,” “could,” “might,” “may,” “e.g.,” and the like, unless specifically stated otherwise, or otherwise understood within the context as used, is generally intended to convey that certain examples include, while other examples do not include, certain features, elements, and/or steps. Thus, such conditional language is not generally intended to imply that features, elements and/or steps are in any way required for one or more examples or that one or more examples necessarily include logic for deciding, with or without author input or prompting, whether these features, elements and/or steps are included or are to be performed in any particular example.

The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list. The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Similarly, the use of “based at least in part on” is meant to be open and inclusive, in that a process, step, calculation, or other action “based at least in part on” one or more recited conditions or values may, in practice, be based on additional conditions or values beyond those recited. Headings, lists, and numbering included herein are for ease of explanation only and are not meant to be limiting.

The various features and processes described above may be used independently of one another or may be combined in various ways. All possible combinations and sub-combinations are intended to fall within the scope of the present disclosure. In addition, certain method or process blocks may be omitted in some embodiments. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed examples. Similarly, the example systems and components described herein may be configured differently than described. For example, elements may be added to, removed from, or rearranged compared to the disclosed examples.

What is claimed is:

1. A key structure for a keyed input device, the key structure comprising:
a housing;
a plunger extending from a top side of the housing and configured to be depressed and move along a linear range of motion;
a mechanical transmission device including and input and an output;
a rotating element,
wherein the plunger is coupled to the input of the mechanical transmission device,
wherein the rotating element is coupled to the output of the mechanical transmission device, and
wherein the mechanical transmission device converts linear motion of the plunger at the input to a rotation motion of the rotating element at the output;
a magnet coupled to the rotating element;
a magnetic sensor configured adjacent to the magnet and operable to generate rotation sensor data corresponding to a rotation of the magnet; and
one or more processors configured to control the magnetic sensor and detect a movement of the plunger along the linear range of motion based on the rotation sensor data.

2. The key structure of claim 1 wherein the magnetic sensor is a Hall Effect sensor.

3. The key structure of claim 1 wherein the mechanical transmission device is a gear system or belt drive system.

4. The key structure of claim 3 wherein the gear system includes a rack and pinion system.

5. The key structure of claim 3 wherein the gear system includes a miter gear system.

6. The key structure of claim 1 wherein the detected movement includes plunger position and a speed of movement of the plunger.

7. The key structure of claim 6 wherein the magnet sensor is axially aligned with an axis of the rotating element.

8. The key structure of claim 6 wherein the magnet sensor is radially aligned with a side of the rotating element.

9. The key structure of claim 1 wherein the plunger, mechanical transmission device, rotating element, magnet, and magnetic sensor are contained within the housing.

10. The key structure of claim 1 wherein the input device is a keyboard.

11. A method of operating a key structure, the method comprising:
receiving an input corresponding to a linear motion of a plunger;
translating the linear motion of the plunger to a rotational motion of a rotating element, the rotating element including a magnet coupled thereto;
controlling a magnetic sensor configured adjacent to the magnet to generate rotation sensor data corresponding to a rotation of the magnet; and
detecting the linear motion of the plunger based on the rotation sensor data.

12. The method of claim 11 wherein translating the linear motion of the plunger to a rotational motion of a rotating element is performed by a mechanical transmission device with an input and output, wherein the plunger is coupled to the input of the mechanical transmission device, and wherein the rotating element is coupled to the output of the mechanical transmission device.

13. The method of claim 12 further comprising a housing that contains the mechanical transmission device, rotating element, magnet, magnetic sensor, and at least a portion of the plunger.

14. The method of claim 12 wherein the mechanical transmission device is a gear system or belt drive system.

15. The method of claim 14 wherein the gear system includes a rack and pinion system.

16. The method of claim 14 wherein the gear system includes a miter gear system.

17. The method of claim 11 wherein the magnetic sensor is a Hall Effect sensor.

18. The method of claim 11 wherein detecting the linear motion of the plunger includes plunger position and speed of movement.

19. The method of claim 11 wherein the magnet sensor is axially aligned with an axis of the rotating element.

20. The method of claim 11 wherein the magnet sensor is radially aligned with a side of the rotating element.
